(19) United States
(12) Patent Application Publication
(10) Pub. No.: US 2026/0364964 A1
(43) Pub. Date: Nov. 19, 2026

(54) MEDIUM CONVEYANCE DEVICE AND CONTROL METHOD FOR MEDIUM CONVEYANCE DEVICE

(71) Applicant: SEIKO EPSON CORPORATION, Tokyo (JP)

(72) Inventor: Atsushi IMAMURA, SHIOJIRI-SHI (JP)

(21) Appl. No.: 19/678,009

(22) Filed: May 14, 2026

(30) Foreign Application Priority Data
May 15, 2025 (JP) 2025-081799

(51) Int. Cl. B41J 15/16; B41J 11/00; B41J 15/04

(52) U.S. Cl. CPC B41J 15/16; B41J 11/002; B41J 15/04

(57) ABSTRACT

According to an aspect of the present disclosure, there is provided a medium conveyance device including a feeding unit configured to feed a medium, a first conveyance unit configured to convey the medium fed by the feeding unit, a winding unit configured to wind the medium conveyed by the first conveyance unit, a tension applying unit configured to apply tension to the medium, and a control unit configured to control the tension applying unit. The control unit causes the tension applying unit to take a first time when causing the tension applying unit to increase the tension from a first tension to a second tension larger than the first tension and causes the tension applying unit to take a second time longer than the first time when causing the tension applying unit to reduce the tension from the second tension to the first tension.

The present application is based on, and claims priority from JP Application Serial Number 2025-081799, filed May 15, 2025, the disclosure of which is hereby incorporated by reference herein in its entirety.

### BACKGROUND

### 1. Technical Field

The present disclosure relates to a medium conveyance device and a control method for a medium conveyance device.

### 2. Related Art

Various medium conveyance devices that convey media have been used. Among the medium conveyance devices, there is a medium conveyance device that conveys a medium while applying tension to the medium. For example, JP-A-2017-170817 discloses a printer including a conveyance unit that conveys a recording medium while applying tension to the recording medium.

JP-A-2017-170817 is an example of the related art.

The printer disclosed in JP-A-2017-170817 is capable of changing the tension applied to the recording medium and changes the tension for ten seconds both when increasing the tension and when reducing the tension. However, if the time in reducing the tension is short, the medium is likely to slacken. On the other hand, the time for changing the tension is preferably short in order to suppress deterioration in responsiveness of the medium conveyance device (an increase in a time from reception of an instruction from a user until a start of an operation) and deterioration in productivity (an increase in a time required for conveying the medium).

### SUMMARY

According to an aspect of the present disclosure, there is provided a medium conveyance device including: a feeding unit configured to feed a medium; a first conveyance unit configured to convey the medium fed by the feeding unit; a winding unit configured to wind the medium conveyed by the first conveyance unit; a tension applying unit configured to apply tension to the medium; and a control unit configured to control the tension applying unit, wherein the control unit causes the tension applying unit to take a first time when causing the tension applying unit to increase the tension from a first tension to a second tension larger than the first tension and causes the tension applying unit to take a second time longer than the first time when causing the tension applying unit to reduce the tension from the second tension to the first tension.

According to another aspect of the present disclosure, there is provided a control method for a medium conveyance device including: a feeding unit configured to feed a medium; a first conveyance unit configured to convey the medium fed by the feeding unit; a winding unit configured to wind the medium conveyed by the first conveyance unit; and a tension applying unit configured to apply tension to the medium, the control method including: causing the tension applying unit to take a first time when causing the tension applying unit to increase the tension from a first tension to a second tension larger than the first tension; and causing the tension applying unit to take a second time longer than the first time when causing the tension applying unit to reduce the tension from the second tension to the first tension.

### BRIEF DESCRIPTION OF THE DRAWINGS

FIG. 1 is a side view of a recording device according to an embodiment of the present disclosure.

FIG. 2 is a graph illustrating tension control of the recording device illustrated in FIG. 1.

FIG. 3 is a schematic diagram illustrating tension applied among constituent members at the time when the tension control is illustrated using the recording device illustrated in FIG. 1 and is a diagram illustrating a case in which the torque of a post-platen discharge roller is increased and then the torque of a post-drying furnace discharge nip roller pair is increased when platen tension and drying tension are increased.

FIG. 4 is a schematic diagram illustrating tension applied among the constituent members at the time when the tension control is illustrated using the recording device illustrated in FIG. 1 and is a diagram illustrating a case in which the torque of the post-drying furnace discharge nip roller pair is increased and then the torque of the post-platen discharge roller is increased when the platen tension and the drying tension are increased.

### DESCRIPTION OF EMBODIMENTS

First, the present disclosure is schematically explained.

According to a first aspect of the present disclosure, there is provided a medium conveyance device including: a feeding unit configured to feed a medium; a first conveyance unit configured to convey the medium fed by the feeding unit; a winding unit configured to wind the medium conveyed by the first conveyance unit; a tension applying unit configured to apply tension to the medium; and a control unit configured to control the tension applying unit, wherein the control unit causes the tension applying unit to take a first time when causing the tension applying unit to increase the tension from a first tension to a second tension larger than the first tension and causes the tension applying unit to take a second time longer than the first time when causing the tension applying unit to reduce the tension from the second tension to the first tension.

According to this aspect, the control unit causes the tension applying unit to take the first time when causing the tension applying unit to increase the tension from the first tension to the second tension and causes the tension applying unit to take the second time longer than the first time when causing the tension applying unit to reduce the tension from the second tension to the first tension. Therefore, it is possible to prevent the medium from slackening because a time in reducing the tension increases and it is also possible to prevent productivity from being deteriorated because a time in increasing the tension decreases. That is, it is possible to suitably change, in a short time, the tension applied to the medium while suppressing slackening of the medium. The tension applying unit may be configured to also serve as any one of the feeding unit, the first conveyance unit, and the winding unit.

A medium conveyance device according to a second aspect of the present disclosure is an aspect dependent from the first aspect, wherein the control unit causes the tension applying unit to maintain the second tension during the conveyance of the medium, reduce the tension from the second tension to the first tension when the conveyance of the medium is stopped, and increase the tension from the first tension to the second tension when the conveyance of the medium is resumed after being stopped.

According to this aspect, the control unit causes the tension applying unit to maintain the second tension during the conveyance of the medium, reduce the tension from the second tension to the first tension when the conveyance of the medium is stopped, and increase the tension from the first tension to the second tension when the conveyance of the medium is resumed after being stopped. By causing the tension applying unit to reduce the tension in stopping the conveyance of the medium, it is possible to suppress a load on the medium or the medium conveyance device. By relatively reducing the first time in resuming the conveyance of the medium as explained above, for example, a response time from execution of an instruction operation of the user to actual movement of the medium decreases and usability is improved.

A medium conveyance device according to a third aspect of the present disclosure is an aspect dependent from the first or second aspect, wherein the control unit causes the tension applying unit to reduce the tension from the second tension to the first tension when a predetermined time elapsed after the conveyance of the medium was stopped.

According to this aspect, when the predetermined time elapsed after the conveyance of the medium was stopped, the control unit causes the tension applying unit to reduce the tension from the second tension to the first tension. As explained above, when the conveyance of the medium is stopped, by causing the tension applying unit to reduce the tension when the predetermined time elapsed, when the conveyance of the medium is resumed before the predetermined time elapses, a time for causing the tension applying unit to increase the tension again is unnecessary and usability is improved.

A medium conveyance device according to a fourth aspect of the present disclosure is an aspect dependent from any one of the first to third aspects, wherein the tension applying unit is provided in at least one of the feeding unit, the first conveyance unit, and the winding unit, and, when target torque applied to a drive unit of the tension applying unit when the tension applying unit applies the first tension is represented as first torque and target torque applied to the drive unit of the tension applying unit when the tension applying unit applies the second tension is represented as second torque, the control unit sets a torque change rate in changing the target torque from the second torque to the first torque to be smaller than a torque change rate in changing the target torque from the first torque to the second torque.

According to this aspect, when the target torque applied to the drive unit of the tension applying unit when the tension applying unit applies the first tension is represented as the first torque and the target torque applied to the drive unit of the tension applying unit when the tension applying unit applies the second tension is represented as the second torque, the torque change rate in changing the target torque from the second torque to the first torque is set to be smaller than the torque change rate in changing the target torque from the first torque to the second torque. With the configuration explained above, it is possible to easily change a time of a tension change by changing the torque change rate.

A medium conveyance device according to a fifth aspect of the present disclosure is an aspect dependent from any one of the first to fourth aspects, further including a detection unit configured to detect the tension, wherein the first conveyance unit includes the tension applying unit, a first conveyance roller pair configured to nip and convey the medium, and a second conveyance roller configured to convey the medium without nipping the medium, the detection unit is located between the first conveyance roller pair and the second conveyance roller, and the control unit controls the first conveyance unit according to the tension detected by the detection unit.

According to this aspect, the first conveyance unit includes the tension applying unit, the first conveyance roller pair configured to nip and convey the medium, and the second conveyance roller configured to convey the medium without nipping the medium, the detection unit is located between the first conveyance roller pair and the second conveyance roller, and the control unit controls the first conveyance unit according to the tension detected by the detection unit. As explained above, it is possible to appropriately adjust the tension by adjusting the tension according to a detection result of the detection unit. It is possible to easily adjust the tension by controlling both conveyance units upstream and downstream in a conveyance direction of a detection position by the detection unit.

A medium conveyance device according to a sixth aspect of the present disclosure is an aspect dependent from the fifth aspect, wherein, when causing the tension applying unit to increase the tension, the control unit causes the tension applying unit to increase the tension by changing torque applied to a drive unit of the first conveyance roller pair and then changing torque applied to a drive unit of the second conveyance roller.

According to this aspect, when causing the tension applying unit to increase the tension, the control unit changes the torque applied to the drive unit of the first conveyance roller pair and then changes the torque applied to the drive unit of the second conveyance roller. That is, by increasing, first, the torque of the first conveyance roller pair to which the torque is easily transmitted by nipping the medium, it is possible to prevent the second conveyance roller, which does not nip the medium, from slipping. Therefore, it is possible to efficiently change the tension.

A medium conveyance device according to a seventh aspect of the present disclosure is an aspect dependent from the fifth or sixth aspect, wherein, when causing the tension applying unit to reduce the tension, the control unit causes the tension applying unit to reduce the tension by changing torque applied to a drive unit of the second conveyance roller and then changing torque applied to a drive unit of the first conveyance roller pair.

According to this aspect, when causing the tension applying unit to reduce the tension, the control unit changes the torque applied to the drive unit of the second conveyance roller and then changes the torque applied to the drive unit of the first conveyance roller pair. That is, by reducing, later, the torque of the first conveyance roller pair to which the torque is easily transmitted by nipping the medium, it is possible to prevent the second conveyance roller, which does not nip the medium, from slipping. Therefore, it is possible to efficiently change the tension.

A medium conveyance device according to an eighth aspect of the present disclosure is an aspect dependent from the sixth or seventh aspect, further including a drying unit configured to dry the medium, wherein the drying unit is located between the first conveyance roller pair and the second conveyance roller.

According to this aspect, the drying unit is located between the first conveyance roller pair and the second conveyance roller. When the medium is dried by the drying unit, the medium sometimes shrinks. However, by performing torque control, it is possible to cope with a change in the tension due to the shrinkage of the medium.

A medium conveyance device according to a ninth aspect of the present disclosure is an aspect dependent from the eighth aspect, further including: a processing unit configured to perform processing on the medium; and a second conveyance unit configured to convey the medium to the processing unit, wherein the control unit performs position control of controlling the second conveyance unit based on a position in a conveyance direction of the medium, and the processing unit is located between the second conveyance unit and the drying unit.

According to this aspect, the medium conveyance device includes the processing unit configured to perform processing on the medium and the second conveyance unit configured to convey the medium to the processing unit, the control unit performs the position control of controlling the second conveyance unit based on the position in the conveyance direction of the medium, and the processing unit is located between the second conveyance unit and the drying unit. Since the position control has high processing accuracy, with the configuration explained above, it is possible to improve the processing accuracy by performing the position control on the second conveyance unit before the processing.

A medium conveyance device according to a tenth aspect of the present disclosure is an aspect dependent from any one of the first to seventh aspects, further including: a processing unit configured to perform processing on the medium; and a drying unit configured to dry the medium processed by the processing unit, wherein the tension applying unit applies the tension to the medium located in the processing unit and the drying unit.

According to this aspect, the medium conveyance device includes the processing unit configured to perform processing on the medium and the drying unit configured to dry the medium processed by the processing unit, and the tension applying unit applies the tension to the medium located in the processing unit and the drying unit. With the configuration explained above, for example, in the processing unit and the drying unit to which the medium is requested to be conveyed, in particular, in a state in which the tension is high, it is possible to temporarily reduce the tension according to necessity and it is possible to suppress a load on the medium or the medium conveyance device.

A control method for a medium conveyance device according to an eleventh aspect of the present disclosure is a control method for a medium conveyance device including: a feeding unit configured to feed a medium; a first conveyance unit configured to convey the medium fed by the feeding unit; a winding unit configured to wind the medium conveyed by the first conveyance unit; and a tension applying unit configured to apply tension to the medium, the control method including: causing the tension applying unit to take a first time when causing the tension applying unit to increase the tension from a first tension to a second tension larger than the first tension; and causing the tension applying unit to take a second time longer than the first time when causing the tension applying unit to reduce the tension from the second tension to the first tension.

According to this aspect, the control unit causes the tension applying unit to take the first time when causing the tension applying unit to increase the tension from the first tension to the second tension and causes the tension applying unit to take the second time longer than the first time when causing the tension applying unit to reduce the tension from the second tension to the first tension. Therefore, it is possible to prevent the medium from slackening because a time in reducing the tension increases and it is also possible to prevent productivity from being deteriorated because a time in increasing the tension decreases. That is, it is possible to suitably change, in a short time, the tension applied to the medium while suppressing slackening of the medium.

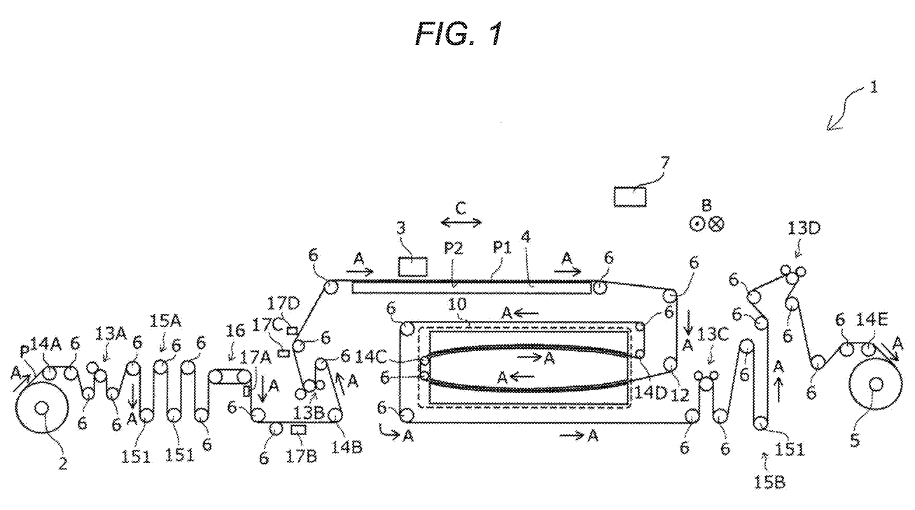

Hereinafter, an embodiment according to the present disclosure is specifically explained with reference to the drawings. First, an overview of a recording device 1, which is an example of a medium conveyance device of the present disclosure, is explained with reference to FIG. 1. As illustrated in FIG. 1, the recording device 1 in the present embodiment includes a feeding unit 2 that rotates to feed a roll-shaped medium P, a winding unit 5 that rotates to wind the medium P conveyed from the feeding unit 2, and a recording head 3 serving as a recording unit that ejects liquid ink to form an image on the recording surface P1 of the medium P conveyed in a conveyance direction A in a conveyance path from the feeding unit 2 to the winding unit 5. The recording device 1 includes a platen 4 that supports the medium P in an image forming region where an image is formed by the recording head 3 and a plurality of driven rollers 6 provided in the conveyance path of the medium P. Furthermore, the recording device 1 in the present embodiment includes a control unit 7 including a CPU and a storage unit. The constituent members of the recording device 1 in the present embodiment are driven by control by the control unit 7.

The recording head 3 is provided on a side facing the recording surface P1 of the medium P conveyed in the conveyance direction A and ejects ink to form an image on the recording surface P1 in a state in which a rear surface P2 on the side opposite to the recording surface P1 of the medium P is supported by the platen 4. Specifically, the recording device 1 in the present embodiment performs recording by reciprocating the recording head 3 in the scanning direction C extending along the conveyance direction A. More specifically, the recording device 1 in the present embodiment intermittently drives (intermittently conveys) the medium P in the conveyance direction A, reciprocates the recording head 3 in the scanning direction C, and ejects the ink from the recording head 3 to perform recording.

The recording head 3 in the present embodiment can complete, with one scanning (one pass), image formation in the entire image forming region supported by the platen 4 on the recording surface P1 and can also complete the image formation by performing a plurality of times of scanning (a plurality of passes) of the entire image forming region.

As explained above, the recording head 3 in the present embodiment is configured to perform recording by being reciprocated in the scanning direction C extending along the conveyance direction A. However, a configuration of the recording head 3 is not particularly limited. Instead of the recording head 3 that performs recording by being reciprocated in the scanning direction C extending along the conveyance direction A, the recording device 1 may include the recording head 3 that performs recording by being reciprocated in a width direction B intersecting the conveyance direction A or may include a so-called line head in which nozzles that eject the ink are provided side by side in the width direction B over the entire width direction B of the medium P and recording is performed in a state in which a recording head is stopped.

When the medium P wound with the recording surface P1 facing the outer side as illustrated in FIG. 1 is used, the feeding unit 2 can feed the medium P by rotating clockwise in FIG. 1. On the other hand, when the medium P wound with the recording surface P1 facing the inner side is used, the feeding unit 2 can feed the medium P by rotating counterclockwise in FIG. 1.

In a conveyance path of the medium P from the feeding unit 2 to a position where the platen 4 and the recording head 3 face each other, the recording device 1 includes a feeding tension roller 14A capable of detecting tension applied to the medium P fed from the feeding unit 2, the plurality of driven rollers 6, and a feeding conveyance nip roller pair 13A. The recording device 1 includes a feeding dancer roller unit 15A including dancer rollers 151 capable of applying tension to the medium P, a web guide 16, a pre-platen tension roller 14B, and a medium conveyance nip roller pair 13B. Furthermore, the recording device 1 includes an end portion detection sensor 17A capable of detecting the end portion in the width direction B of the medium P in order to detect skew conveyance and positional deviation in the width direction B of the medium P, a joint sensor 17B for detecting a joint of the medium P, a foreign matter detection sensor 17C, and a medium mark sensor 17D capable of detecting a mark attached to the medium P, such as an eye mark. Note that the recording device 1 in the present embodiment is capable of performing additional printing for further performing recording on the recording surface P1 of the medium P on which recording has already been performed by the recording device 1 but controls recording timing according to control by the control unit 7 using the medium mark sensor 17D at the time of the additional printing.

The feeding tension roller 14A is a roller capable of detecting tension in the conveyance direction A of the medium P fed from the feeding unit 2. Tension applied to the medium P fed from the feeding unit 2 is adjusted by detecting tension applied to the medium P in the feeding tension roller 14A and controlling the torque of a motor, which rotates a rotating shaft of the feeding unit 2, such that the tension reaches predetermined tension.

The feeding conveyance nip roller pair 13A is controlled by the control unit 7 detecting the position in the up-down direction of the dancer rollers 151 of the feeding dancer roller unit 15A and controlling a feed amount or speed of a motor, which drives the feeding conveyance nip roller pair 13A, such that the position reaches a predetermined position. Here, the feeding dancer roller unit 15A includes two dancer rollers 151 movable in the up-down direction and applies tension to the medium P with the dancer rollers 151. The tension in the conveyance direction A of the medium P in the conveyance path can be adjusted by detecting tension based on displacement in the up-down direction of the dancer rollers 151.

The web guide 16 includes two rollers extended in the width direction B and capable of adjusting an angle with respect to the conveyance direction A and can suppress skew conveyance of the medium P by adjusting the angle of the rollers according to the control of the control unit 7 based on a detection result of a not-illustrated end portion detection sensor. The joint sensor 17B is a sensor that, when a medium having a joint obtained by joining media P with a tape or the like is used as the roll-shaped medium P, detects the joint.

The medium conveyance nip roller pair 13B is controlled by the control unit 7 controlling a feeding amount or speed of a motor, which drives the medium conveyance nip roller pair 13B, to feed the medium P by a predetermined conveyance amount under predetermined conveyance conditions such as speed or acceleration and deceleration. In other words, the medium conveyance nip roller pair 13B is a roller pair including a driving roller that is driven by receiving a driving force of a motor controlled by the control unit 7, is disposed further upstream than the recording head 3 in the conveyance direction A, and applies a conveyance force to the medium P and a nip roller that is driven to rotate with the medium P interposed between the nip roller and the driving roller. The control unit 7 controls the motor such that the medium conveyance nip roller pair 13B conveys the medium P by a predetermined conveyance amount under predetermined conveyance conditions such as predetermined speed and acceleration and deceleration. The medium conveyance nip roller pair 13B is a nip roller that nips the recording surface P1 and the rear surface P2 and applies a conveyance force to the medium P. However, since the medium conveyance nip roller pair 13B is disposed to come into contact with the medium P in a region before recording by the recording head 3, there is no contact of the medium conveyance nip roller pair 13B with the ink due to the medium conveyance nip roller pair 13B coming into contact with the recording surface P1.

As illustrated in FIG. 1, a drying unit 10 that dries the ink ejected onto the medium P is provided further downstream in the conveyance direction A than the recording head 3 in the conveyance path of the medium P. In addition to the plurality of driven rollers 6, a post-platen discharge roller 12 is provided in the conveyance path of the medium P from the recording head 3 to the drying unit 10. The post-platen discharge roller 12 is a roller that is driven by receiving a driving force of a motor, which drives the post-platen discharge roller 12, and comes into contact with the rear surface P2 of the medium P to apply a conveyance force to the medium P. Since the post-platen discharge roller 12 is the roller that comes into contact with only the rear surface P2 and applies the conveyance force to the medium P, there is no contact with the ink of the post-platen discharge roller 12 due to the post-platen discharge roller 12 coming into contact with the recording surface P1.

In the conveyance path of the medium P in the drying unit 10, the plurality of driven rollers 6 and an intra-drying furnace tension roller 14C are provided and a contact heating unit that comes into contact with the rear surface P2 of the medium P and dries the medium P is provided. The plurality of driven rollers 6, a post-drying furnace tension roller 14D, a post-drying furnace discharge nip roller pair 13C, a winding dancer roller unit 15B including the dancer roller 151 capable of applying tension to the medium P, a winding conveyance nip unit 13D, and a winding tension roller 14E capable of detecting the tension applied to the medium P wound by the winding unit 5 are provided further downstream in the conveyance direction A than the drying unit 10 up to the winding unit 5.

Here, the tension of the medium P in a recording region corresponding to the position where the platen 4 and the recording head 3 face each other can be adjusted by detecting the tension of the medium P in the post-drying furnace tension roller 14D and controlling the torque of a motor, which drives the post-drying furnace discharge nip roller pair 13C, with the control unit 7 such that the tension reaches a predetermined tension. Furthermore, the tension of the medium P in the recording region corresponding to the position where the platen 4 and the recording head 3 face each other can be adjusted by detecting the tension of the medium P in the intra-drying furnace tension roller 14C and the post-drying furnace tension roller 14D and controlling the torque of a motor, which drives the post-platen discharge roller 12, with the control unit 7 such that the tension reaches a predetermined tension.

The winding conveyance nip unit 13D detects the position in the up-down direction of the dancer roller 151 of the winding dancer roller unit 15B and controls a feeding amount or speed of a motor, which drives the winding conveyance nip unit 13D, such that the position reaches a predetermined position. The tension applied to the medium P wound by the winding unit 5 is adjusted by detecting the tension of the medium P in the winding tension roller 14E and controlling the torque of a motor, which drives the winding unit 5, with the control unit 7 such that the tension reaches a predetermined tension. The tension at this time can be set to taper tension corresponding to a roll diameter of a roll of the medium P wound by the winding unit 5.

As explained above, the recording device 1 in the present embodiment serving as the medium conveyance device includes the feeding unit 2 that feeds the medium P, the first conveyance units such as the post-platen discharge roller 12 and the post-drying furnace discharge nip roller pair 13C that convey the medium P fed by the feeding unit 2, and the winding unit 5 that winds the medium P conveyed by the first conveyance units. Here, the post-platen discharge roller 12 and the post-drying furnace discharge nip roller pair 13C also play a role of tension applying units that apply tension to the medium P. Here, in the recording device 1 in the present embodiment, the control unit 7 is capable of controlling the tension applying units and changing the tension applied to the medium P to first tension and second tension larger than the first tension. Then, the control unit 7 causes the tension applying units to take a first time in increasing the tension applied to the medium P from the first tension to the second tension and take a second time longer than the first time in reducing the tension applied to the medium P from the second tension to the first tension.

By the control unit 7 performing the control explained above, the recording device 1 in the present embodiment can prevent the medium P from slackening because a time in reducing the tension applied to the medium P increases and can also prevent productivity from being deteriorated because a time in increasing the tension applied to the medium P decreases. That is, the recording device 1 in the present embodiment can suitably change, in a short time, the tension applied to the medium P while suppressing the slackening of the medium P. Hereinafter, specific control by the control unit 7 in the recording device 1 in the present embodiment for the tension applied to the medium P is explained.

In the present embodiment, tension applied to the medium P in a region facing the platen 4 and an internal region of the drying unit 10 is explained. However, the explanation can also be applied to a region other than the region facing the platen 4 and the internal region of the drying unit 10. Furthermore, the explanation may be applied to a medium conveyance device other than the recording device. A configuration in which the tension applying units are the feeding unit 2 and the winding unit 5 and the tension applied to the medium P is adjusted by driving control for the feeding unit 2 and the winding unit 5 may be adopted or a configuration in which the tension applying unit is a dancer roller or an idler used for tension adjustment for a belt may be adopted. In that case or the like, the explanation may be applied to a region on a side closer to either the feeding unit 2 side or the winding unit 5 side.

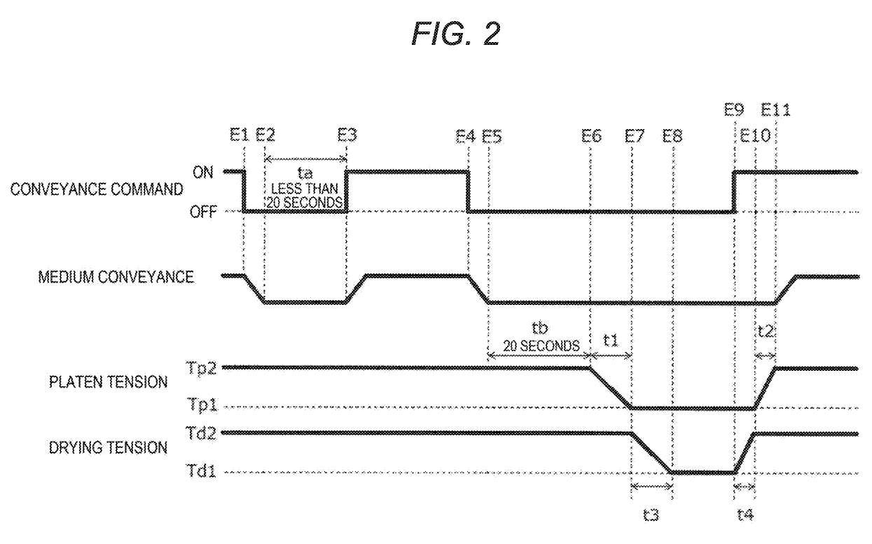

Hereinafter, how the control unit 7 causes the tension applying units to take the first time in increasing the tension applied to the medium P from the first tension to the second tension and take the second time in reducing the tension applied to the medium P from the second tension to the first tension is specifically explained with reference to FIG. 2. FIG. 2 is a graph illustrating tension control by the control unit 7 in the recording device 1 in the present embodiment.

For example, in the recording device 1 that is conveying the medium P, when a user turns off a conveyance command at an elapsed time E1 and instructs a conveyance stop via an external computer coupled to the recording device 1, the conveyance of the medium P is stopped from the elapsed time E1 to an elapsed time E2. Platen tension Tp1 corresponding to tension applied to the medium P in the region facing the platen 4 during conveyance standby of the medium P, in other words, after the conveyance of the medium P is stopped for a while is 20 N. On the other hand, platen tension Tp2 corresponding to tension applied to the medium P in the region facing the platen 4 during the conveyance of the medium P is 90 N.

Drying tension Td1 corresponding to tension applied to the medium P in a region from a position immediately after discharge from the drying unit 10 to the post-drying furnace discharge nip roller pair 13C during the conveyance standby of the medium P is 30 N. On the other hand, drying tension Td2 corresponding to the tension applied to the medium P in the region from the position immediately after discharge from the drying unit 10 to the post-drying furnace discharge nip roller pair 13C during the conveyance of the medium P is 100 N. That is, the platen tension Tp1 and the drying tension Td1 correspond to the first tension and the platen tension Tp2 and the drying tension Td2 correspond to the second tension.

At the elapsed time E1 and the elapsed time E2, the platen tension is the platen tension Tp2 and the drying tension is the drying tension Td2. Thereafter, when the user turns on the conveyance command and instructs conveyance resumption at an elapsed time E3, the control unit 7 executes an operation of resuming the conveyance. If a time ta from the elapsed time E2 to the elapsed time E3 at this time is less than 20 seconds, the platen tension is maintained at the platen tension Tp2 and the drying tension is maintained at the drying tension Td2 even at the elapsed time E3.

Furthermore, thereafter, when the user turns off the conveyance command and instructs a conveyance stop at an elapsed time E4, the conveyance of the medium P is stopped from the elapsed time E4 to an elapsed time E5. When a time tb, specifically, 20 seconds elapse in a state in which the conveyance of the medium P is stopped and, at an elapsed time E6, the control unit 7 controls the platen tension to decrease from the platen tension Tp2 to the platen tension Tp1 for a time t1. Then, after the time t1 from the elapsed time E6 (after an end of the decrease in the platen tension), at an elapsed time E7, the control unit 7 controls the drying tension to decrease from the drying tension Td2 to the drying tension Td1 for a time t3.

After an elapsed time E8 after the time t3 from the elapsed time E7, at an elapsed time E9, when the user turns on the conveyance command and instructs conveyance resumption, the control unit 7 executes an operation of resuming the conveyance. Before resuming the conveyance, the control unit 7 controls the drying tension to increase from the drying tension Td1 to the drying tension Td2 for a time t4. At an elapsed time E10 after the time t4 from the elapsed time E9 (after an end of the increase in the drying tension), the control unit 7 controls the platen tension to increase from the platen tension Tp1 to the platen tension Tp2 for a time t2. At an elapsed time E11 after the time t2 from the elapsed time E10, the control unit 7 resumes the conveyance.

At this time, concerning the platen tension, the control unit 7 causes the tension applying units to take the time t2, which is the first time, in increasing the tension applied to the medium P from the platen tension Tp1, which is the first tension, to the platen tension Tp2, which is the second tension, and take the time t1, which is the second time longer than the first time, in reducing the tension applied to the medium P from the platen tension Tp2, which is the second tension, to the platen tension Tp1, which is the first tension. Similarly, concerning the drying tension, the control unit 7 causes the tension applying units to take the time t4, which is the first time, in increasing the tension applied to the medium P from the drying tension Td1, which is the first tension, to the drying tension Td2, which is the second tension, and take the time t3, which is the second time longer than the first time, in reducing the tension applied to the medium P from the drying tension Td2, which is the second tension, to the drying tension Td1, which is the first tension.

As explained above, the recording device 1 in the present embodiment can set the platen tension Tp1 to 20 N, set the platen tension Tp2 to 90 N, set the drying tension Td1 to 30 N, and set the drying tension Td2 to 100 N. However, the tensions are not limited to such tensions. The time tb, which is a threshold of a time taken from a stop of conveyance of the medium P to a start of the conveyance of the medium P and is a time for reducing the platen tension and the drying tension, is set to 20 seconds in the embodiment explained above. However, the time tb is not limited to such a time. For example, the recording device 1 in the present embodiment can set the time t1 to 3 seconds, set the time t2 to 1 second, set the time t3 to 3 seconds, and set the time t4 to 1 second. However, the times are not limited to such times. However, it is preferable that the time t1 > the timet2 and the time t3 > the time t4.

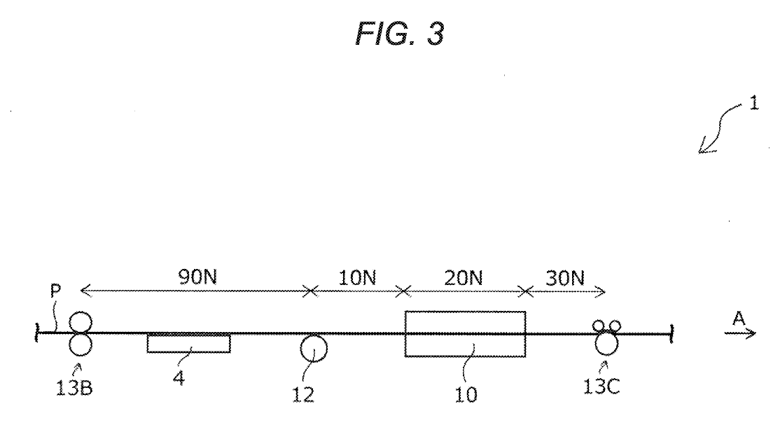

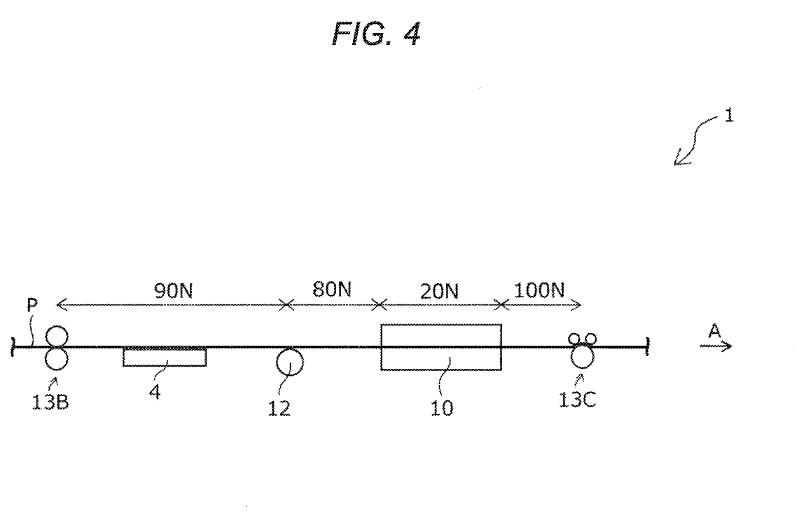

In the embodiment explained above, when the platen tension and the drying tension are reduced, the platen tension is reduced and then the drying tension is reduced and, when the platen tension and the drying tension are increased, the drying tension is increased and then the platen tension is increased. In other words, when the platen tension and the drying tension are reduced, the torque of the post-platen discharge roller 12 is reduced and then the torque of the post-drying furnace discharge nip roller pair 13C is reduced and, when the platen tension and the drying tension are increased, the torque of the post-drying furnace discharge nip roller pair 13C is increased and then the torque of the post-platen discharge roller 12 is increased. By performing the control explained above, slip of the post-platen discharge roller 12 is suppressed. This is explained below with reference to FIGS. 3 and 4. In the recording device 1 in the present embodiment, it is assumed that a tension loss of 20 N occurs from the upstream end portion to the downstream end portion in the conveyance direction A of the drying unit 10.

First, contrary to the embodiment explained above, a case in which the torque of the post-platen discharge roller 12 is increased and then the torque of the post-drying furnace discharge nip roller pair 13C is increased in increasing the platen tension and the drying tension is conceived. In this case, as illustrated in FIG. 3, tension of 90 N is applied in a region from the medium conveyance nip roller pair 13B to the post-platen discharge roller 12 (an upstream region in the conveyance direction A of the post-platen discharge roller 12). Then, tension of 30 N is applied in a region from the downstream end portion in the conveyance direction A of the drying unit 10 to the post-drying furnace discharge nip roller pair 13C. Then, when the tension loss of 20 N in the drying unit 10 is considered, tension of 30 N - 20 N = 10 N is applied to a downstream region in the conveyance direction A of the post-platen discharge roller 12. Therefore, a large difference in tension of 90 N - 10 N = 80 N occurs between the upstream region in the conveyance direction A of the post-platen discharge roller 12 and the downstream region in the conveyance direction A of the post-platen discharge roller 12. For this reason, a frictional force between the post-platen discharge roller 12 and the medium P is easily exceeded and the post-platen discharge roller 12 easily slips.

On the other hand, as in the present embodiment, a case in which the torque of the post-drying furnace discharge nip roller pair 13C is increased and then the torque of the post-platen discharge roller 12 is increased in increasing the platen tension and the drying tension is conceived. In this case, as illustrated in FIG. 4, tension of 90 N is applied in a region from the medium conveyance nip roller pair 13B to the post-platen discharge roller 12 (an upstream region in the conveyance direction A of the post-platen discharge roller 12). Then, tension of 100 N is applied in a region from the downstream end portion in the conveyance direction A of the drying unit 10 to the post-drying furnace discharge nip roller pair 13C. Then, when the tension loss of 20 N in the drying unit 10 is considered, tension of 100 N - 20 N = 80 N is applied to a downstream region in the conveyance direction A of the post-platen discharge roller 12. Therefore, only a small difference in tension of 90 N - 80 N = 10 N occurs between the upstream region in the conveyance direction A of the post-platen discharge roller 12 and the downstream region in the conveyance direction A of the post-platen discharge roller 12. For this reason, the frictional force between the post-platen discharge roller 12 and the medium P is less easily exceeded and the post-platen discharge roller 12 less easily slips. The case in which the platen tension and the drying tension are increased is explained as an example above. However, when the platen tension and the drying tension are reduced, for the same reason, the post-platen discharge roller 12 less easily slips when the platen tension is reduced and then the drying tension is reduced.

As explained above, in the recording device 1 in the present embodiment, the control unit 7 maintains the platen tension Tp2 and the drying tension Td2, which are the second tensions, during the conveyance of the medium P as represented by a time until the elapsed time E1, a time from the elapsed time E3 to the elapsed time E4, a time after the elapsed time E11, and the like in FIG. 2. As represented by a time from the elapsed time E7 to the elapsed time E10 in FIG. 2, when stopping the conveyance of the medium P, the control unit 7 reduces the tension applied to the medium P from the second tension to the platen tension Tp1, which is the first tension. As represented by a time from the elapsed time E8 to the elapsed time E9 in FIG. 2, when stopping the conveyance of the medium P, the control unit 7 reduces the tension applied to the medium P from the second tension to the drying tension Td1, which is the first tension. Furthermore, as represented by a time from the elapsed time E9 to the elapsed time E11 in FIG. 2, when resuming the conveyance of the medium P after stopping the conveyance, the control unit 7 increases the tension applied to the medium P from the first tension to the second tension.

By reducing the tension in stopping the conveyance of the medium P, it is possible to suppress a load on the medium P and the recording device 1. By setting the times t2 and t4 in resuming the conveyance of the medium P relatively short, for example, it is possible to reduce a response time from execution of an instruction operation of the user to actual movement of the medium P and it is possible to improve usability. On the other hand, when the conveyance of the medium P is stopped, since the user does not need to wait for an operation of the recording device 1, it can be said that the influence on usability is small even if a time in reducing the tension is relatively long. Therefore, the recording device 1 in the present embodiment can generally improve usability. The tension may be changed at the same timing as the conveyance stop of the medium P. However, without being limited to the configuration, the tension may be changed by shifting timing from the conveyance stop of the medium P.

In the recording device 1 in the present embodiment, as illustrated in FIG. 2, the control unit 7 reduces the tension from the second tension to the first tension when 20 seconds (the time tb), which is the predetermined time, has elapsed after the conveyance of the medium P was stopped. As explained above, when the conveyance of the medium P is stopped, since the tension applied to the medium P is reduced only when the predetermined time has elapsed, for example, as in a time from the elapsed time E2 to the elapsed time E3 in FIG. 2, a time for increasing, again, the tension applied to the medium P is unnecessary in resuming the conveyance of the medium P before the predetermined time elapses (the time ta) and it is possible to improve usability. For example, as in a time from the elapsed time E5 to the elapsed time E9 in FIG. 2, when the tension applied to the medium P is reduced when the predetermined time elapses after the conveyance of the medium P is stopped, since the user does not recognize that the user waits for the operation of the recording device 1, it can be said that the influence on usability is small even if a time in reducing the tension applied to the medium P is relatively long.

Here, in the present embodiment, the tension applying units are the post-platen discharge roller 12 and the post-drying furnace discharge nip roller pair 13C serving as the first conveyance units. However, the tension applying units are not limited to being provided in the first conveyance units and may be provided in at least one of the feeding unit 2, the first conveyance unit, and the winding unit 5. When a target torque applied to a drive unit of the tension applying unit when the tension applying unit applies the first tension is represented as first torque and a target torque applied to the drive unit of the tension applying unit when the tension applying unit applies the second tension is represented as second torque, it is preferable that the control unit 7 performs control for setting a torque change rate in changing the target torque from the second torque to the first torque smaller than a torque change rate in changing the target torque from the first torque to the second torque.

Here, the torque change rate in changing the target torque from the second torque to the first torque corresponds to a gradient of the platen tension at the time t1 from the elapsed time E6 to the elapsed time E7 in FIG. 2 and a gradient of the drying tension at the time t3 from the elapsed time E7 to the elapsed time E8 in FIG. 2. The torque change rate in changing the target torque from the first torque to the second torque corresponds to a gradient of the platen tension at the time t2 from the elapsed time E10 to the elapsed time E11 in FIG. 2 and a gradient of the drying tension at the time t4 from the elapsed time E9 to the elapsed time E10 in FIG. 2. It is possible to easily change a time of a tension change by performing the control in the present embodiment to change the torque change rate. However, without being limited to the control explained above, for example, position control for controlling the position of the medium P based on the position in the up-down direction of the dancer rollers 151 of the feeding dancer roller unit 15A or the winding dancer roller unit 15B, speed control, and the like may be executed.

The recording device 1 in the present embodiment includes the intra-drying furnace tension roller 14C and the post-drying furnace tension roller 14D, both of which also play the role of the detection units capable of detecting the tension applied to the medium P. The recording device 1 includes, as the first conveyance units, the post-drying furnace discharge nip roller pair 13C, which is a first conveyance roller pair that nips and conveys the medium P, and the post-platen discharge roller 12, which is a second conveyance roller that conveys the medium P without nipping the medium P, both of the post-drying furnace discharge nip roller pair 13C and the post-platen discharge roller 12 also playing the role of the tension applying units. Here, the intra-drying furnace tension roller 14C and the post-drying furnace tension roller 14D serving as the detection units are located between the post-drying furnace discharge nip roller pair 13C, which is the first conveyance roller pair, and the post-platen discharge roller 12, which is the second conveyance roller, in the conveyance path of the medium P. Then, the control unit 7 controls the post-drying furnace discharge nip roller pair 13C and the post-platen discharge roller 12 according to the tension applied to the medium P detected by the intra-drying furnace tension roller 14C and the post-drying furnace tension roller 14D serving as the detection units.

As explained above, by adjusting the tension applied to the medium P according to detection results of the intra-drying furnace tension roller 14C and the post-drying furnace tension roller 14D serving as the detection units, it is possible to appropriately adjust the tension applied to the medium P. It is possible to easily adjust the tension applied to the medium P by controlling the post-drying furnace discharge nip roller pair 13C and the post-platen discharge roller 12, which are both conveyance units upstream and downstream in the conveyance direction of detection positions by the intra-drying furnace tension roller 14C and the post-drying furnace tension roller 14D serving as the detection units. Note that either the first conveyance roller pair or the second conveyance roller may be provided upstream in the conveyance direction and the detection units may be provided separately from the intra-drying furnace tension roller 14C and the post-drying furnace tension roller 14D.

In the recording device 1 in the present embodiment, as represented by the time from the elapsed time E9 to the elapsed time E11 in FIG. 2, when increasing the tension applied to the medium P, the control unit 7 drives the post-drying furnace discharge nip roller pair 13C to change the drying tension from the drying tension Td1 to the drying tension Td2 and then drives the post-platen discharge roller 12 to change the platen tension from the platen tension Tp1 to the platen tension Tp2. In other words, the control unit 7 performs torque control on the post-platen discharge roller 12 and the post-drying furnace discharge nip roller pair 13C, changes torque applied to a drive unit of the post-drying furnace discharge nip roller pair 13C, which is the first conveyance roller pair, and then changes torque applied to a drive unit of the post-platen discharge roller 12, which is the second conveyance roller, to increase the tension applied to the medium P.

With the configuration explained above, by increasing, first, the torque of the first conveyance roller pair to which torque is easily transmitted by nipping the medium P, the recording device 1 in the present embodiment can prevent the second conveyance roller, which does not nip the medium P, from slipping. Therefore, the recording device 1 in the present embodiment can efficiently change tension. It goes without saying that the torque of the second conveyance roller, which does not nip the medium P, may be changed after a change in the torque of the first conveyance roller pair, which nips the medium P, is completed. However, if start timings of the changes in the torques are shifted, the change in the torque of the second conveyance roller, which does not nip the medium P, may be started before the change in the torque of the first conveyance roller pair, which nips the medium P, is completed. For example, after the elapsed time E6, the reduction in the drying tension may be started before the elapsed time E7. After the elapsed time E9, the platen tension may be increased before the elapsed time E10.

Furthermore, in the recording device 1 in the present embodiment, as represented by a time from the elapsed time E6 to the elapsed time E8 in FIG. 2, when reducing tension, the control unit 7 reduces the tension applied to the medium P by changing the torque applied to the drive unit of the post-platen discharge roller 12, which is the second conveyance roller, and then changing the torque applied to the drive unit of the post-drying furnace discharge nip roller pair 13C, which is the first conveyance roller pair. With the configuration explained above, by reducing, later, the torque of the first conveyance roller pair to which torque is easily transmitted by nipping the medium P, it is possible to prevent the second conveyance roller, which does not nip the medium P, from slipping. Therefore, the recording device 1 in the present embodiment can efficiently change tension. It goes without saying that the torque of the first conveyance roller pair, which nips the medium P, may be changed after the change in the torque of the second conveyance roller, which does not nip the medium P, is completed. However, if start timings of the changes in the torques are shifted, the change in the torque of the first conveyance roller pair, which nips the medium P, may be started before the change in the torque of the second conveyance roller, which does not nip the medium P, is completed.

As explained above, the recording device 1 in the present embodiment includes the drying unit 10 that dries the medium P. As illustrated in FIG. 1, the drying unit 10 is located between the post-drying furnace discharge nip roller pair 13C, which is the first conveyance roller pair, and the post-platen discharge roller 12, which is the second conveyance roller, in the conveyance path of the medium P. Regardless of whether the medium P is dried or the conveyance is stopped, when the medium P is dried by the drying unit 10, the medium P sometimes shrinks. However, by performing torque control rather than position control on the post-drying furnace discharge nip roller pair 13C and the post-platen discharge roller 12, which is the second conveyance roller, it is possible to take measures for suppressing conveyance failure even when tension applied to the medium P changes because of the shrinkage of the medium P.

As explained above, the recording device 1 in the present embodiment includes the recording head 3, which is an example of a processing unit that performs processing on the medium P, and the medium conveyance nip roller pair 13B, which configures a second conveyance unit that conveys the medium P to the recording head 3. Here, the control unit 7 performs position control for controlling the medium conveyance nip roller pair 13B based on the position in the conveyance direction A of the medium P. As illustrated in FIG. 1, the recording head 3 is located between the medium conveyance nip roller pair 13B and the drying unit 10 in the conveyance path of the medium P.

Since the position control has high conveyance accuracy, with the configuration explained above, the recording device 1 in the present embodiment can improve processing accuracy by performing the position control on the second conveyance unit involved in the conveyance of the medium P before processing (before recording). At this time, if the post-platen discharge roller 12 and the post-drying furnace discharge nip roller pair 13C serving as the first conveyance unit, which is the downstream conveyance unit, are also subjected to the position control, because of, for example, a manufacturing error of the constituent members, even if a conveyance operation by the first conveyance unit and a conveyance operation by the second conveyance unit are synchronized, it is likely that appropriate conveyance cannot be performed because the conveyance operations interfere. However, by performing torque control on the post-platen discharge roller 12 and the post-drying furnace discharge nip roller pair 13C serving as the first conveyance units, appropriate conveyance can be performed. Regardless of whether the medium P is dried or the conveyance is stopped, when the medium P is dried by the drying unit 10, the medium P sometimes shrinks. However, it is also possible to cope with a change in tension applied to the medium P due to the shrinkage of the medium P.

Specifically, in the present embodiment, the post-drying furnace discharge nip roller pair 13C is configured to be capable of performing feedback control by checking a tension value of the post-drying furnace tension roller 14D. When the medium P shrinks by being dried, since the tension applied to the medium P (the tension value of the post-drying furnace tension roller 14D) increases, the post-drying furnace discharge nip roller pair 13C controls the tension to reach target tension through feedback control. At this time, the dancer rollers 151 rise according to the feedback control of the post-drying furnace discharge nip roller pair 13C due to the shrinkage of the medium P. Both of the feeding conveyance nip roller pair 13A and the medium conveyance nip roller pair 13B are position-controlled. However, even if nips of both the nip roller pairs are driven at the same speed, a slight error occurs because of a mechanical error or the like. However, since the dancer rollers 151 of the feeding dancer roller unit 15A are provided to absorb the error, it is possible to suppress the interference. In the present embodiment, the feeding conveyance nip roller pair 13A and the medium conveyance nip roller pair 13B are driven at different speed curves.

To explain from another viewpoint, the recording device 1 in the present embodiment includes the processing unit (the recording head 3) that performs processing on the medium P and the drying unit 10 that dries the medium P processed by the processing unit, and the tension applying units (the post-platen discharge roller 12 and the post-drying furnace discharge nip roller pair 13C) are configured to be capable of applying tension to the medium P located in the processing unit and the drying unit 10. With the configuration explained above, in the processing unit and the drying unit 10 in which the medium P is conveyed in a state in which the tension is particularly high, for example, it is necessary to suppress contact with the recording head 3 or contact with a heater, it is possible to temporarily reduce the tension according to necessity and it is possible to suppress a load on the medium P and the recording device 1.

The present disclosure is not limited to the embodiment explained above and can be implemented in various configurations without departing from the gist of the present disclosure. For example, technical features in the embodiment corresponding to technical features in the aspects explained in the summary of the disclosure can be substituted and combined as appropriate in order to solve a part or all of the problems explained above or in order to achieve a part or all of the effects explained above. The technical features can be deleted as appropriate unless explained in the present specification as essential technical features.

What is claimed is:

1. A medium conveyance device comprising:
a feeding unit configured to feed a medium;
a first conveyance unit configured to convey the medium fed by the feeding unit;
a winding unit configured to wind the medium conveyed by the first conveyance unit;
a tension applying unit configured to apply tension to the medium; and
a control unit configured to control the tension applying unit, wherein
the control unit causes the tension applying unit to take a first time when causing the tension applying unit to increase the tension from a first tension to a second tension larger than the first tension and causes the tension applying unit to take a second time longer than the first time when causing the tension applying unit to reduce the tension from the second tension to the first tension.

2. The medium conveyance device according to claim 1, wherein the control unit causes the tension applying unit to maintain the second tension during the conveyance of the medium, reduce the tension from the second tension to the first tension when the conveyance of the medium is stopped, and increase the tension from the first tension to the second tension when the conveyance of the medium is resumed after being stopped.

3. The medium conveyance device according to claim 2, wherein the control unit causes the tension applying unit to reduce the tension from the second tension to the first tension when a predetermined time elapsed after the conveyance of the medium was stopped.

4. The medium conveyance device according to claim 1, wherein
the tension applying unit is provided in at least one of the feeding unit, the first conveyance unit, and the winding unit, and
when target torque applied to a drive unit of the tension applying unit when the tension applying unit applies the first tension is represented as first torque and target torque applied to the drive unit of the tension applying unit when the tension applying unit applies the second tension is represented as second torque, the control unit sets a torque change rate in changing the target torque from the second torque to the first torque to be smaller than a torque change rate in changing the target torque from the first torque to the second torque.

5. The medium conveyance device according to claim 1, further comprising a detection unit configured to detect the tension, wherein
the first conveyance unit includes the tension applying unit, a first conveyance roller pair configured to nip and convey the medium, and a second conveyance roller configured to convey the medium without nipping the medium,
the detection unit is located between the first conveyance roller pair and the second conveyance roller, and
the control unit controls the first conveyance unit according to the tension detected by the detection unit.

6. The medium conveyance device according to claim 5, wherein, when causing the tension applying unit to increase the tension, the control unit causes the tension applying unit to increase the tension by changing torque applied to a drive unit of the first conveyance roller pair and then changing torque applied to a drive unit of the second conveyance roller.

7. The medium conveyance device according to claim 5, wherein, when causing the tension applying unit to reduce the tension, the control unit causes the tension applying unit to reduce the tension by changing torque applied to a drive unit of the second conveyance roller and then changing torque applied to a drive unit of the first conveyance roller pair.

8. The medium conveyance device according to claim 5, further comprising a drying unit configured to dry the medium, wherein
the drying unit is located between the first conveyance roller pair and the second conveyance roller.

9. The medium conveyance device according to claim 8, further comprising:
a processing unit configured to perform processing on the medium; and
a second conveyance unit configured to convey the medium to the processing unit, wherein
the control unit performs position control of controlling the second conveyance unit based on a position in a conveyance direction of the medium, and
the processing unit is located between the second conveyance unit and the drying unit.

10. The medium conveyance device according to claim 1, further comprising:
a processing unit configured to perform processing on the medium; and
a drying unit configured to dry the medium processed by the processing unit, wherein
the tension applying unit applies the tension to the medium located in the processing unit and the drying unit.

11. A control method for a medium conveyance device including: a feeding unit configured to feed a medium; a first conveyance unit configured to convey the medium fed by the feeding unit; a winding unit configured to wind the medium conveyed by the first conveyance unit; and a tension applying unit configured to apply tension to the medium, the control method comprising:
causing the tension applying unit to take a first time when causing the tension applying unit to increase the tension from a first tension to a second tension larger than the first tension; and
causing the tension applying unit to take a second time longer than the first time when causing the tension applying unit to reduce the tension from the second tension to the first tension.
